(19) United States
(12) Patent Application Publication
(10) Pub. No.: US 2012/0329603 A1
(43) Pub. Date: Dec. 27, 2012

(54) HYBRID VEHICLE

(75) Inventors: Masahiro Yamazaki, Yamagata (JP); Yoshimasa Hayashi, Kanagawa (JP)

(73) Assignee: YGK CO., LTD., Yamagata (JP)

(21) Appl. No.: 13/386,956

(22) PCT Filed: Jun. 27, 2011
(86) PCT No.: PCT/JP2011/064703

§ 371 Date: Jan. 25, 2012

(51) Int. Cl. B60W 10/08

(52) U.S. Cl. 477/3; 903/902; 903/930; 180/65.22

(57) ABSTRACT

A hybrid vehicle is capable of running using an engine and a motor as drive sources and includes an exhaust turbine to be driven and rotated by exhaust of the engine, and a generator which generates power by being driven and rotated by the exhaust turbine. The motor is driven by electric power generated by the generator.

### TECHNICAL FIELD

This invention relates to a technology for collecting exhaust energy of an engine in a hybrid vehicle.

### BACKGROUND ART

A hybrid system by an engine and a motor can be classified into a series type which runs only on motive power of a motor using an engine exclusively for power generation, a parallel type which runs on motive powers of an engine and a motor or only on motive power of one of them, and a series parallel type (split type) as a combination of these series type and parallel type.

JP2000-225871A discloses that, in a vehicle including such a hybrid system, while kinetic energy and position energy of the vehicle are converted into electrical energy and collected by driving a motor generator from a wheel side at the time of deceleration and running downhill, the engine is assisted utilizing the collected electrical energy at the time of acceleration, and vehicle rums only on motive power of the motor at the time of running at a low speed.

### SUMMARY OF INVENTION

In a hybrid vehicle as described above, a basis for the collected electrical energy is work done by an engine. That is, energy to be collected is electrical energy obtained from the net work of the engine.

A ratio of thermal energy effectively used for motive power out of thermal energy of fuel supplied to the engine is a maximum of 30 to 34%. On the other hand, energy discarded as exhaust is composed of thermal energy (J) and dynamic energy which is a product PV (Nm=J) of a pressure P (Pa) and a flow rate V (m³), and the sum of these thermal energy and dynamic energy reaches as high as 35%. Further, heat discarded to a cooling system is 20 to 30%, and a radiation rate from an engine surface is about 5%.

Here, if the flow rate V of the exhaust is a flow rate per unit time (m³/s), the unit of the product PV of the pressure and the flow rate is J/s=W. As a method for converting the energy of the exhaust into work, it is thought to collect the energy as rotational motive power by an exhaust turbine and transmit this rotational motive power to a crankshaft via gears.

However, since a rotational speed difference between the exhaust turbine and the crankshaft is large, a deceleration mechanism for decelerating and transmitting the rotational speed of the exhaust turbine becomes complicated and a part of the motive power is wasted due to a resulting increase in friction or the like. As a result, only a power assist effect of about 3% can be exhibited.

The present invention aims to improve total thermal efficiency by collecting exhaust energy of an engine.

One aspect of the present invention is directed to a hybrid vehicle capable of running using an engine and a motor as drive sources, including an exhaust turbine to be driven and rotated by exhaust of the engine; and a generator which generates power by being driven and rotated by the exhaust turbine; wherein the motor is driven by electric power generated by the generator.

According to the above aspect, energy of the exhaust of the engine is collected by the exhaust turbine and the collected energy is converted into electric power to drive the motor, wherefore the output of the engine can be reduced by as much as the motor is driven and total thermal efficiency of the entire vehicle can be improved.

### BRIEF DESCRIPTION OF DRAWINGS

FIG. 1 is a schematic construction diagram showing the construction of a hybrid vehicle according to a first embodiment of the present invention,

FIG. 2 is a chart showing three-phase drive currents output from a motor controller,

FIG. 3 is a diagram showing the flow of control signals and the flow of energies,

FIG. 4 is a diagram showing a thermal efficiency improvement effect,

FIG. 5 is a graph showing the thermal efficiency improvement effect,

FIG. 6 is a schematic construction diagram showing the construction of a hybrid vehicle according to a second embodiment of the present invention, and

FIG. 7 is a schematic construction diagram showing the construction of a hybrid vehicle according to a third embodiment of the present invention.

### EMBODIMENTS OF INVENTION

Hereinafter, embodiments of the present invention are described with reference to the accompanying drawings.

First, a first embodiment is described.

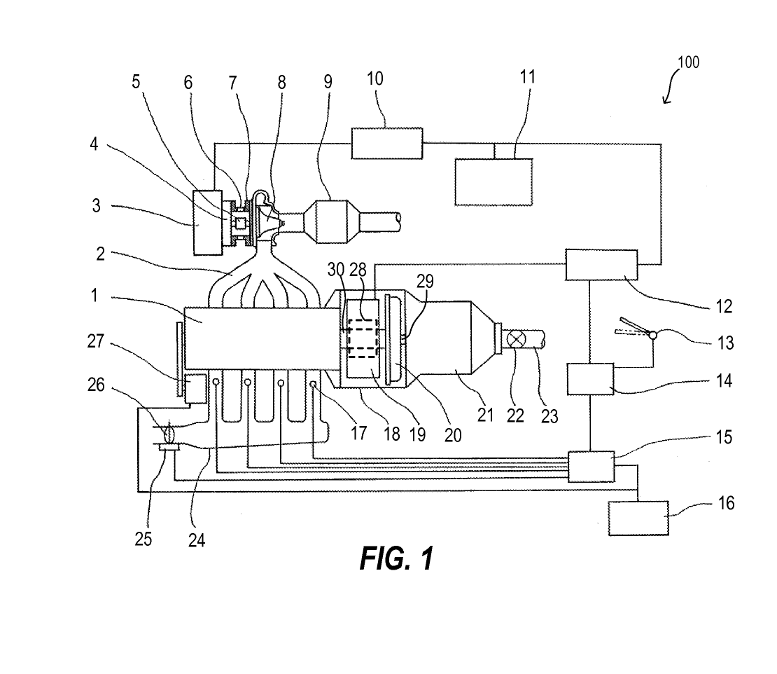

FIG. 1 is a schematic construction diagram showing the construction of a hybrid vehicle 100 in this embodiment. The hybrid vehicle 100 of this embodiment is such that an engine 1, a motor 19 and a transmission 21 are arranged in this order to form a drive force transmission path and can run on at least either one of drive forces of the engine 1 and the motor 19.

The engine 1 and the motor 19 are directly connected in a rotating direction and rotate at the same speed. A clutch 20 is arranged at the output side of the motor 19. In the case of a vehicle including a torque converter, the torque converter is arranged instead of a clutch 20. The motor 19 and the clutch 20 are housed in a bell housing 18. The transmission 21 is provided at an output side of the clutch 20, and motive power is transmitted from an output side of the transmission 21 to drive wheels via a universal joint 22 and a propeller shaft 23.

A rotor 28 of the motor 19 is directly connected to a crankshaft 30 of the engine 1, and the rear end of the crankshaft 30 is connected to the clutch 20. The rotor 28 and the clutch 20 may be fastened to the crankshaft 30 by bolts or the like or may be spline-connected.

Since the crankshaft 30 and the motor 28 are directly connected, torques of the engine 1 and the motor 19 are input to the transmission 21 at the same rotational speed. That is, the sum of the torques of the engine 1 and the motor 19 is input to the transmission 21.

On the other hand, the motor 19 is driven by the drive wheels via the clutch 20 at the time of coasting. Thus, the motor 19 can be operated as a generator 3 (motor generator) in a coasting state where motive power is transmitted from the drive wheels to the engine 1.

In addition to the above construction, the hybrid vehicle 100 includes an exhaust turbine 8 for collecting exhaust energy of the engine 1, a decelerator 4 for decelerating and outputting the rotational speed of the exhaust turbine 8, and the generator 3 to be driven and rotated by an output shaft of the decelerator 4.

Exhaust from the engine 1 swiftly flows into the exhaust turbine 8 through an exhaust manifold 2 to rotate the exhaust turbine 8 at a high speed. The rotation of the exhaust turbine 8 is transmitted to the decelerator 4 via a coupling 5 and drives the generator 3 after having the speed thereof decelerated to ½ to ⅙.

To prevent heat transfer, the coupling 5 is made of a material having low thermal conductivity, e.g. stainless steel or ceramic. Since having better power generation efficiency and better contributing to miniaturization when being rotated at a higher speed, the generator 3 is rotated, for example, at about 20,000 rpm.

An adapter 7 provided between the exhaust turbine 8 and the decelerator 4 prevents heat transfer from the exhaust turbine 8 to the decelerator 4. The adapter 7 houses the coupling 5 inside and includes a vent hole 6 for introducing air for cooling the coupling 5.

The hybrid vehicle 100 further includes a battery 11, an inverter 10, a central controller 14, a motor controller 12 and an engine controller 15 in addition to the above construction.

The battery 11 is a battery or a capacitor for high voltage for storing electric power generated by the generator 3 and supplying electric power to the motor 19.

The inverter 10 converts electric power generated by the generator 3 into a direct current having a specified voltage (e.g. 200 V) and feeds it to the motor 19 or the battery 11. Further, the inverter 10 is capable of electrically adjusting a load of the generator 3 and can suppress an increase in the rotational speed of the exhaust turbine 8 by increasing a power generation load.

The central controller 14 calculates sharing rates of the engine 1 and the motor 19 to a requested output based on a depression amount and a depression speed of an accelerator pedal transmitted from an accelerator pedal depression amount detection sensor 13.

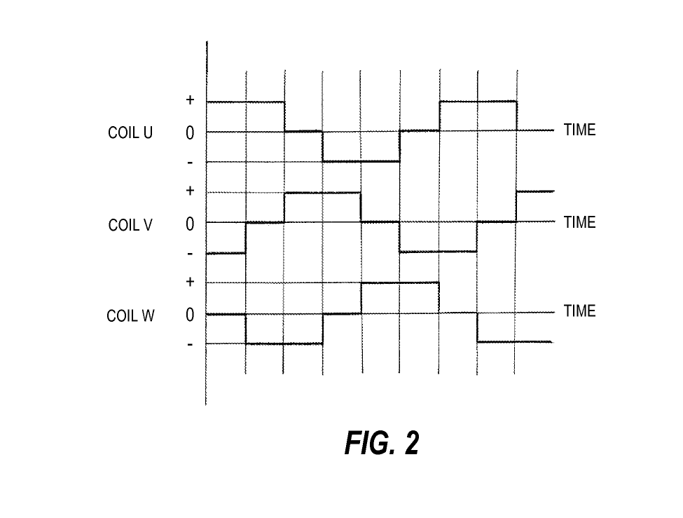

The motor controller 12 adjusts the voltage and frequency of the electric power supplied from the battery 11 or the motor 19 in accordance with a command from the central controller 14 and controls the drive force of the motor 19. As shown in FIG. 2, respective phase currents of three-phase drive currents output from the motor controller 12 are respectively supplied to respective coils (coil U, coil V, coil W) of three-phase coils of a stator to generate a rotating magnetic field in the stator. A rotational torque is generated in a permanent magnet of the rotor 28 by this rotating magnetic field and a drive force is output from an output shaft of the rotor 28.

The engine controller 15 controls an opening of a throttle 26, a fuel injection amount (pulse width) of an injector 17 and an ignition timing in accordance with electric power stored in a vehicle battery 16 based on a command from the central controller 14. The vehicle battery 16 stores electric power generated by an alternator 27 driven and rotated by the engine 1.

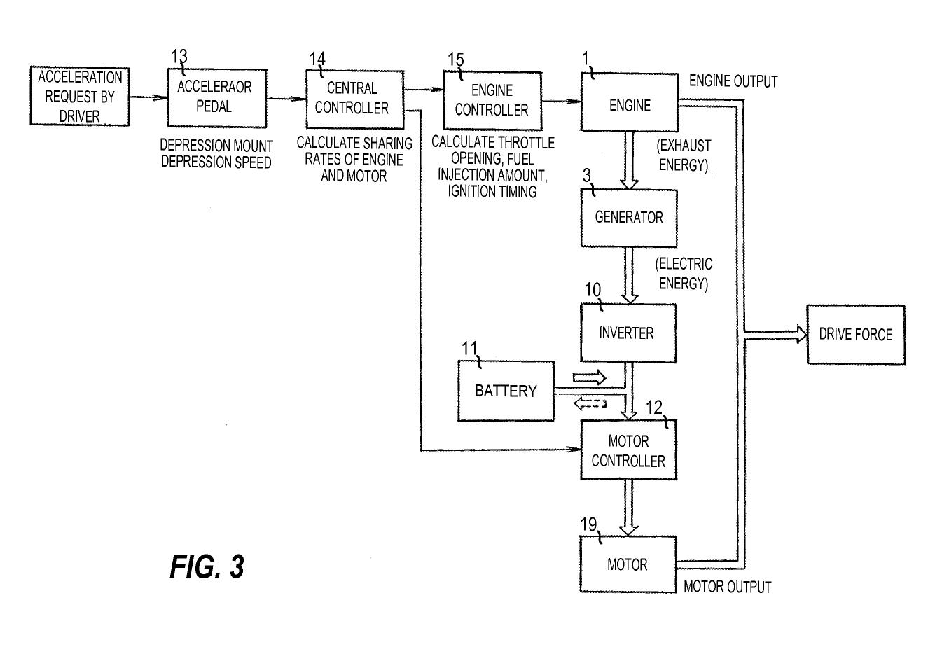

FIG. 3 shows the flow of control signals and the flow of energies in a system of the hybrid vehicle 100. In FIG. 3, thin arrows indicate the flow of signals and thick arrows indicate the flow of energies.

The exhaust energy of the engine 1 is collected by the exhaust turbine 8 to drive the generator 3. Electric power generated by the generator 3 is converted into a direct current having a specified voltage by the inverter 10 and has the voltage and frequency thereof controlled by the motor controller 12 to drive the motor 19. Alternatively, the electric power generated by the generator 3 is stored in the battery 11.

When an output voltage of the motor controller 12 increases, a current also increases in proportion to the voltage if resistance is constant. Accordingly, the electric power is proportional to the square of the voltage. Out of the electric power generated by the generator 3, a part which is not stored in the battery 11 is substantially directly controlled by the motor controller 12 and supplied to the motor 19.

An output (drive force) request of a driver is first transmitted to the accelerator pedal, and the depression amount and depression speed of the accelerator pedal are input to the central controller 14. The central controller 14 determines respective output shares of the engine 1 and the motor 19 necessary to meet the output requested by the driver.

Here, in a state where a charged state of the battery 11 is higher than a predetermined highly charged state (e.g. 80%) (fully charged state or a state close to the fully charged state), the electric power generated by the generator 3 is directly supplied to the motor controller 12 without charging the battery 11. As a simple method for preventing overcharging of the battery 11, it is thought to, when a voltage of the fully charged battery 11 is, for example, 200 V, set a voltage at an exit side of the inverter 10 at 200 to 205 V substantially equal to 200 V.

The engine controller 15 electronically controls the opening of the throttle 26, the fuel injection amount (pulse width) of the injector 17 and the ignition timing to realize an engine output determined by the central controller 14.

Since the motor 19 generates motive power using electric power constantly generated as long as the engine 1 is in an operating state, the sum of motive powers generated by the engine 1 and the motor 19 may become larger than an output requested by the driver. In this case, the engine controller 15 reduces an intake air amount of the engine 1 by means of a throttle actuator 25 in accordance with a signal from the central controller 14. If the intake air amount is reduced, the pulse width relating to the injector 17 controlled by the engine controller 15 is automatically narrowed and the amount of fuel injected into an intake manifold is reduced.

Further, when the engine 1 is a diesel engine, the throttle 26 and the throttle actuator 25 are not present. Thus, the engine controller 15 directly controls fuel injection amounts from injection valves arranged in respective cylinders.

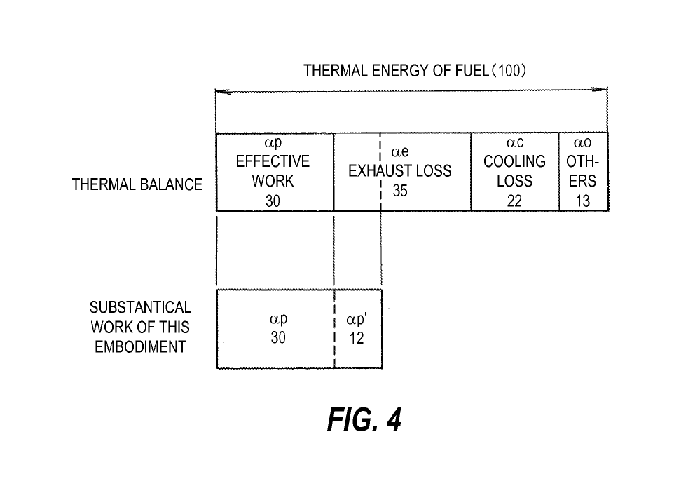

Next, a thermal efficiency improvement effect is described with reference to FIG. 4. Thermal balance when thermal energy of fuel is 100% is assumed, for example, as follows.

Effective work of the engine 1 (αp): 30%

Exhaust loss (αe): 35%

Cooling loss (αc): 25%

Others (α0): 13%

α0 is a total of radiation loss from the surface of the engine 1 and mechanical loss.

The thermal efficiency improvement effect of this embodiment is calculated using these values below.

Electric energy αp′ which can be regenerated from the exhaust loss (αe) is:

αp′=αe×ηt×ηm×ηg (1)

if ηt, ηm and ηg denote efficiency of the exhaust turbine 8, mechanical efficiency of a deceleration gear of the decelerator 4 and a product of efficiency of the generator 3 and that of the inverter 10, respectively.

Here, if ηt=0.4, ηm=0.98 and ηg=0.9, αe=0.35. Thus, the electric energy αp′ to be regenerated is 0.35×0.4×0.98×0.9=0.12. Since this is added to the efficiency of the engine 1, energy extracted as motive power from the engine 1 is αp+αp′=0.3+0.12=0.42.

Conventionally, a conversion ratio of thermal energy of fuel supplied to the engine 1 into motive power has been 0.3, but it is increased to 0.42 by the motor 19 according to this embodiment. This means that (αp+αp′)/αp=0.42/0.3=1.4 based on αp=0.3, i.e. a thermal efficiency improvement of 40% is realized. Further, a feature of this embodiment is that regenerable electric power also increases as the output of the engine 1 increases.

When αp and αe have values as described above, αe=(0.35/0.3)×αp. Even if this proportionality constant (0.35/0.3) changes depending on a driving condition, a functional relationship invariably holds between αe and αp (output).

Here, if the energy of the fuel supplied to the engine 1 is same, an engine output is proportional to αp. That is, Lp=K×αp, wherein Lp is engine output and K is proportionality constant. Further, since the functional relationship holds between αe and αp as described above, αp′ is also a function of the engine output from Equation (1).

In this case, since an output of the motor 19 is 0.4Lp,

L=Lp+0.4Lp (2).

An output L requested by the driver to move the vehicle is Lp+0.4 Lp as in Equation (2), i.e. αp+αp′.

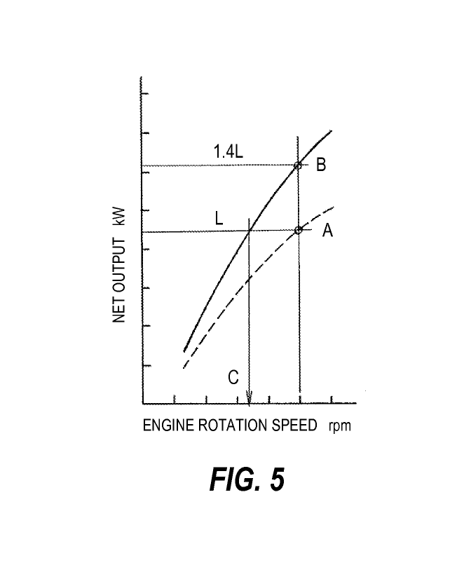

Thus, the output of the engine 1 is sufficient to be Lp/(Lp+0.4 Lp)=1/1.4=0.71. As shown in FIG. 5, when a conventional engine output is represented by a dotted line, an output of a power unit, which is addition of this and an output of the motor 19 given by regenerated electric power, is represented by a solid line. Since the conventional engine output A becomes B in this embodiment, a rotational speed C lower than A is sufficient to obtain the same output.

Next, an effect of improving fuel consumption (BSFC) is described.

Fuel consumption of the engine 1 itself at a thermal efficiency of 30% is about 280 g/kWh when a low calorific value of gasoline is 4260 kj/kg. Although the sum of the outputs of the engine 1 and the motor 19 is 1.4-fold of the output of the engine 1 alone, the mass of consumed fuel remains unchanged at 280 g. Since the sum of the outputs of the engine 1 and the motor 19 is 1.4-fold of the output of the engine 1 alone, total BSFC obtained by dividing the mass of the consumed fuel by this is 280/1.4=200 g/kWh. The fuel consumption is improved by (280-200)/280=0.286, i.e. about 29%.

In a normal driving condition, the output L requested by the driver can be met by the sum of the outputs of the engine 1 and the motor 19. However, the output L requested by the driver suddenly increases at the time of sudden acceleration or running uphill, a drive output may be insufficient. In this case, the output of the motor 19 is increased by adding the electric power stored in the battery 11 in response to a command form the central controller 14.

Because of an output increase by the motor 19, neither a turbo lag nor a shocking torque variation occurs unlike conventional turbo engine vehicles, whereby driving performance is improved. Note that αp′ can be made larger than αp since the electric power from the battery 11 is added in this case.

If the electric power is sufficiently stored in the battery 11 and the battery 11 cannot be charged any further (if the charged state is higher than the predetermined highly charged state), the output share of the engine 1 is reduced and the electric power is consumed by increasing the output of the motor 19.

Further, the rotational speed of the exhaust turbine 8 can be detected from the frequency of an alternating current generated by the generator 3. In the case of excessive rotation of the exhaust turbine 8, the output of the engine 1 is reduced and the output share of the motor 19 is increased by that much to increase an electrical load of the generator 3 while an output as a power plant is kept constant. In this way, the same action as a waste gate valve of the turbo engine 1 can be exhibited.

At the time of idling, work done by pistons is equal to friction loss and the above αp becomes 0. However, electric power can be obtained even at the time of idling since the exhaust turbine 8 rotates to generate power as long as the engine 1 rotates.

In this way, the rotation of the engine 1 can be assisted by the motor 19 and fuel can be saved while a predetermined idle rotational speed is ensured. Further, since idle rotation is assisted by the motor 19, a rotation variation decreases and smooth idling is realized, wherefore the idle rotational speed can be reduced.

As described above, in this embodiment, the energy of the exhaust of the engine 1 is collected by the exhaust turbine 8 and the collected energy is converted into electric power to drive the motor 19. Thus, the output of the engine 1 can be reduced by as much as the motor 19 is driven, the amount of fuel supplied to the engine 1 can be reduced and the total thermal efficiency of the entire vehicle can be improved.

Accordingly, it becomes possible to reduce the displacement of the engine 1 and improve driving performance of the lean-burn engine vehicle with less power.

Further, the output ratio of the engine 1 and the motor 19 is controlled based on an output requested by the driver, and the output of the engine 1 is reduced when the sum of the outputs of the engine 1 and the motor 19 exceeds the output requested by the driver while being increased when the sum of the outputs falls short of the requested output. Thus, the engine output can be assisted by the motor output while the output requested by the driver is met, and the total thermal efficiency of the vehicle can be reduced by reducing the output of the engine 1.

Further, the output of the engine 1 is assisted by constantly generated electric power at the time of normal driving and power assist by the motor 19 is performed utilizing electric power from the battery 11 when a large output is requested such as at the time of acceleration. Thus, energy exhausted from the engine 1 can be efficiently collected, the total thermal efficiency can be improved and the output requested by the driver can be more reliably given.

Further, if the charged state of the battery 11 is higher than the predetermined highly charged state, electric power generated by the generator 3 is directly supplied to the motor 19 without passing through the battery 11, wherefore deterioration caused by overcharging of the battery 11 can be prevented.

Further, since the rotational speed of the exhaust turbine 8 is decelerated and transmitted to the generator 3 by the decelerator 4, the generator 3 can be rotated at such a rotational speed as to provide good power generation efficiency.

Further, since the coupling 5 is interposed between the exhaust turbine 8 and the decelerator 4, the transfer of heat of the exhaust turbine 8 to the decelerator 4 can be prevented and a very small misalignment of rotating shafts can be absorbed.

Next, a second embodiment is described.

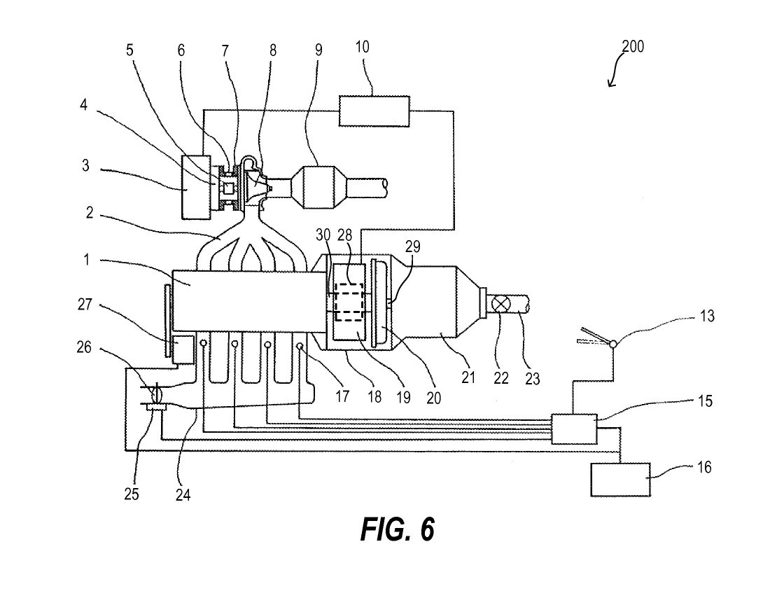

FIG. 6 is a schematic construction diagram showing the construction of a hybrid vehicle 200 in this embodiment. This embodiment differs from the first embodiment in that the battery 11, the motor controller 12 and the central controller 14 are not provided.

The hybrid vehicle 200 in this embodiment has a simple system in which an engine 1 and a motor 19 which operates on electrical energy regenerated from exhaust energy constitute one power plant. Electric power generated by a generator 3 is directly supplied to the motor 19 via an inverter 10. The inverter 10 converts an alternating current into a direct current and, simultaneously, converts all electrical energy generated by the generator 3 into rectangular wave currents in three phases (three-phase drive currents) as in FIG. 2 to drive the motor 19.

Accordingly, the motor 19 is constantly driven only by the electric power regenerated from the exhaust energy, wherefore the output of the motor 19 is constantly less than that of the engine 1 as described with reference to FIG. 4.

An output requested by a driver is input as a depression amount and a depression speed of an accelerator pedal to an engine controller 15, and the engine controller 15 electronically controls an opening of a throttle 26, a fuel injection amount (pulse width) of an injector 17 and an ignition timing based on the requested output. Since the exhaust energy increases as the output of the engine 1 increases, the amount of power generation accordingly increases and the output of the motor 19 also increases.

Similar to the first embodiment, the sum of the outputs of the engine 1 and the motor 19 becomes equal to the output requested by the driver. However, since individual output shares are not known to the driver, driver's feeling similar to that given by a vehicle which runs only on the engine 1 can be realized.

Further, since the battery 11, the motor controller 12 and the central controller 14 are not necessary, the system can be simplified and made lighter.

Next, a third embodiment is described.

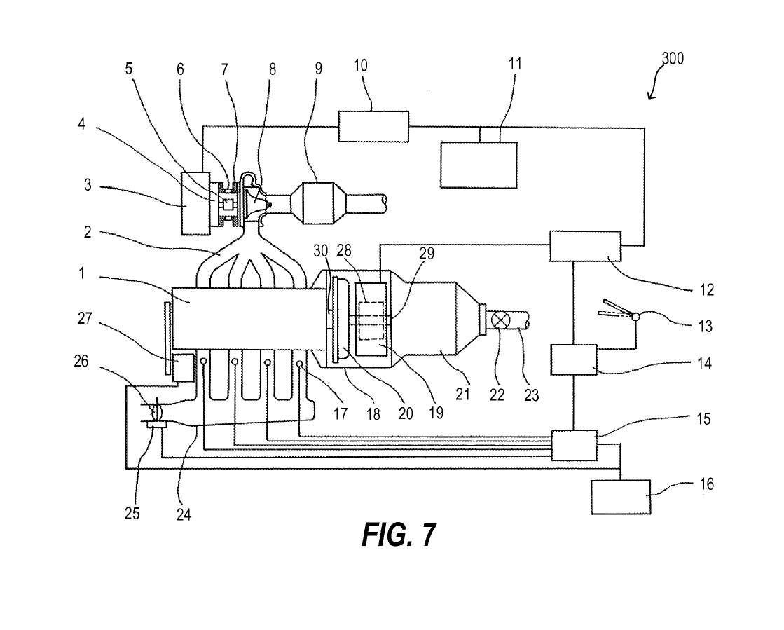

FIG. 7 is a schematic construction diagram showing the construction of a hybrid vehicle 300 in this embodiment. This embodiment differs from the first embodiment in the arrangement of a clutch 20 and a motor 19, and the motor 19 is arranged at an output side of the clutch 20. A rotor 28 of the motor 19 is spline-connected to a drive shaft 29 for transmitting motive power to a transmission 21.

Thus, if the motor 19 is energized with the clutch 20 disengaged, the vehicle can run only on electric motive power (EV running). Further, in a vehicle including a torque converter instead of the clutch 20, kinetic energy can be directly regenerated without being influenced by slippage of the torque converter from drive wheels at the time of coasting.

Similar to the first embodiment, the central controller 14 calculates the value of the output requested by the driver from the depression amount of the accelerator pedal, determines output shares of the engine 1 and the motor 19 and sends output control signals to the motor controller 12 and the engine controller 15. The motor controller 12 controls electric power supplied to the motor 19 and the engine controller 15 controls output performance of the engine 1.

The embodiments of the present invention have been described above. The above embodiments are merely illustration of application examples of the present invention and not of the nature to limit the technical scope of the present invention to the specific constructions of the above embodiments. Various changes can be made without departing from the gist of the present invention.

For example, although the rotational speed of the exhaust turbine 8 is decelerated and transmitted to the generator 3 by the decelerator 4 in the above first to third embodiments, the decelerator 4 may be omitted if the diameter of the exhaust turbine 8 is made larger to set a rotational speed of about 20,000 rpm. In this case, the exhaust turbine 8 and the generator 3 are directly connected by the coupling 5 and can be driven at the same rotational speed.

The present application claims a priority based on Japanese Patent Application No. 2011-51543 filed with the Japanese Patent Office on Mar. 9, 2011, all the contents of which are hereby incorporated by reference.

1. A hybrid vehicle capable of running using an engine and a motor as drive sources, comprising:
an exhaust turbine to be driven and rotated by exhaust of the engine; and
a generator for generating power by being driven and rotated by the exhaust turbine;
wherein the motor is driven by electric power generated by the generator.

2. The hybrid vehicle according to claim 1, comprising:
an output controller which controls an output ratio of the engine and the motor based on a requested output to the vehicle.

3. The hybrid vehicle according to claim 2, wherein:
the output controller reduces the output of the engine when the sum of the outputs of the engine and the motor exceeds the requested output while increases the output of the engine when the sum of the outputs falls short of the requested output.

4. The hybrid vehicle according to claim 1, further comprising a battery for storing the electric power generated by the generator, wherein:
the motor is driven by the electric power stored in the battery.

5. The hybrid vehicle according to claim 4, wherein:
the output controller supplies the electric power stored in the battery to the motor when the sum of the outputs falls short of the requested output even if the output of the engine is increased.

6. The hybrid vehicle according to claim 4, wherein:
the electric power generated by the generator is directly supplied to the motor without passing through the battery when a charged state of the battery is higher than a predetermined highly charged state.

7. The hybrid vehicle according to claim 1, further comprising:
a decelerator which decelerates and transmits the rotational speed of the exhaust turbine to the generator.

8. The hybrid vehicle according to claim 7, further comprising:
a coupling interposed between the exhaust turbine and the decelerator.

9. The hybrid vehicle according to claim 1, wherein:
the motor is a motor generator capable of power running and regeneration.
